(19) United States
(12) Patent Application Publication
(10) Pub. No.: US 2005/0132539 A1
(43) Pub. Date: Jun. 23, 2005

(54) Cushion grips for spray bottle

(76) Inventor: Thomas Herrmann, Bloomfield Hills, MI (US)

Correspondence Address: John G. Posa;Gifford, Krass, Groh, Sprinkle,, Anderson & Citkowski, P.C., 280 N. Old Woodward Ave., Suite 400, Birmingham, MI, 48009-5394, US

(21) Appl. No.: 10/748,910

(22) Filed: Dec. 22, 2003

(51) Int. Cl. B62B 1/00

(52) U.S. Cl. 16/431

(57) ABSTRACT

In conjunction with a spray bottle having a manually operated, elongated trigger-type grip, this invention improves upon the existing art by providing a cover for the grip. In the preferred embodiments, such a cover is in the form of a sleeve of pliable material having an open end, a closed end, an internal length and an internal cross-sectional dimension, and wherein the length is on the order 2.5 cm or less; and internal cross-sectional dimension is on the order of 1 cm or less. The material may by vinyl, PVC, or other polymeric, preferably of the chemically resistant variety. The internal cross section of the sleeve may be circular or rectangular, depending upon the grip type, and may be composed of a coextensive liner and overlay.

### REFERENCE TO RELATED APPLICATION

This application claims priority from U.S. Provisional Patent Application Ser. No. 60/435,208, filed Dec. 20, 2002, the entire content of which is incorporated herein by reference.

### FIELD OF THE INVENTION

This invention relates generally to spray bottles and, in particular, to cushion grips for spray bottles.

### BACKGROUND OF THE INVENTION

Currently, spray bottles of the type used for window cleaning, watering plants, and the like, include hard plastic grips, which can cause fatigue to a user's hand or fingers due to prolonged use. This situation could and should be remedied.

### SUMMARY OF THE INVENTION

In conjunction with a spray bottle having a manually operated, elongated trigger-type grip, this invention improves upon the existing art by providing a cover for the grip. In the preferred embodiments, such a cover is in the form of a sleeve of pliable material having an open end, a closed end, an internal length and an internal cross-sectional dimension, and wherein the length is on the order 2.5 cm or less; and internal cross-sectional dimension is on the order of 1 cm or less. The material may by vinyl, PVC, or other polymeric, preferably of the chemically resistant variety.

The internal cross section of the sleeve may be circular or rectangular, depending upon the grip type, and may be composed of a coextensive liner and overlay. Durometer is preferably on the order of 25-100 SHORE A; for example, a duromer of 50-55 SHORE A is particularly useful.

In a particular embodiment, the length measures from 1.35 to 1.4 cm, having an internal cross section that is circular with a diameter measuring 0.4 to 0.5 cm. Alternatively, the length may measure from 2.0 to 2.5 cm, having an internal cross section which is circular with a diameter measuring 0.35 to 0.4 cm. Or the length may measure approximately 2.0 cm, having an internal cross section which is circular with a diameter of approximately 0.5 cm. As a further alternative, the length may measure approximately 1.5 cm with a rectangular cross section internal dimensions of 0.1 by 0.5 cm, more or less. Or the length may measure approximately 1.25 cm with a rectangular cross section internal dimensions of 0.25 by 0.625 cm, more or less. Wall thickness is preferably 0.1 cm or less.

### BRIEF DESCRIPTION OF THE DRAWINGS

FIG. 1 illustrates a first preferred embodiment of the invention;

FIG. 2 shows an alternative embodiment of the invention suitable for a different type of spray bottle trigger, including an outer overlay material and a liner material;

FIG. 3 is a drawing of a further alternative embodiment for a different spray bottle trigger, also including a liner and an overlay material;

FIG. 4 illustrates yet a different alternative embodiment of the invention intended for other types of trigger spray grips, and having a generally square cross-section;

FIG. 5 illustrates a further, different alternative embodiment of the invention for a different type of trigger handle;

FIG. 6 is a specification for a spray head applicable to the cushion grips of FIGS. 1 and 2;

FIG. 7 is a specification for a spray head applicable to the cushion grip of FIG. 3;

FIGS. 8 and 9 are specifications for spray heads applicable to the cushion grip of FIG. 4; and

FIG. 10 is a specification for a spray head applicable to the cushion grip of FIG. 5.

### DETAILED DESCRIPTION OF THE INVENTION

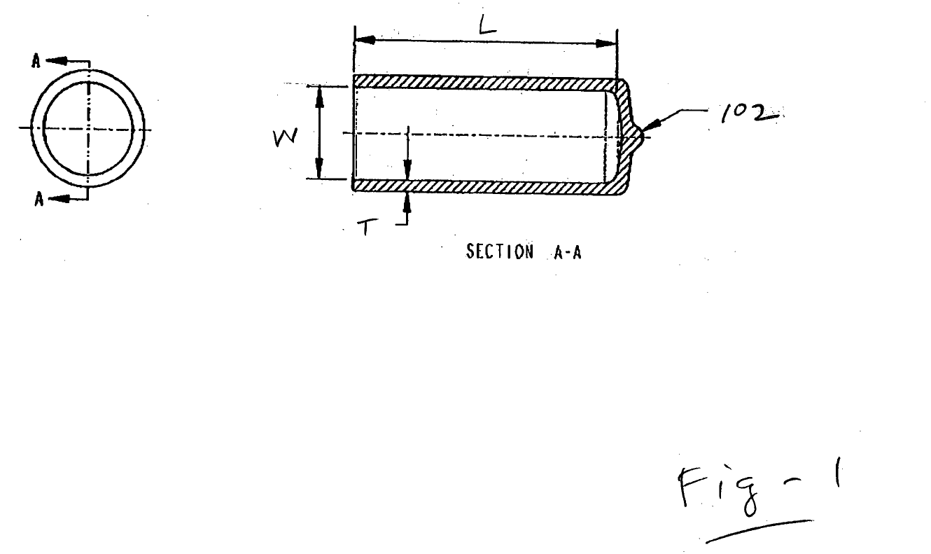

This invention addresses the shortcoming of the existing art by providing cushion grips for existing spray bottles. FIGS. 1-5 illustrate different embodiments of the invention, with different dimensions to suit the offerings of different manufacturers. In FIG. 1, the dimension L is on the order of 1.375; W is on the order of 0.468; and T is on the order of 0.060. All dimensions are in metric with a certain level of dimensional tolerance due primarily to manufacturing considerations. The preferred material is vinyl plastisol, and the color of variable, including translucent/transparent. The surface type is preferably a medium texture with a low to dull gloss. The durometer is preferably on the order of 53±5 SHORE A; the tear mark of any suitable dimension is shown at 102.

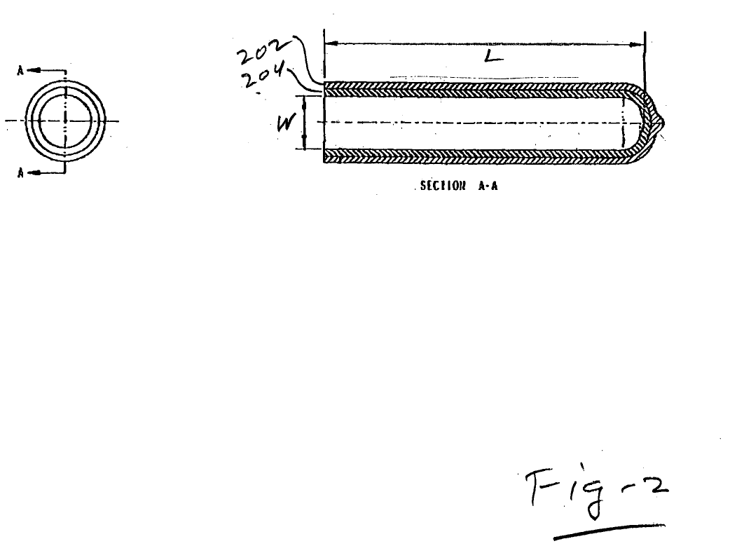

FIG. 2 shows an alternative embodiment of the invention suitable for a different type of spray bottle trigger, including an outer overlay material 202 and a liner material 204, both constructed of vinyl plastisol. The liner can be made in any color, though “natural” is preferred, with a durometer of 89±5 SHORE A with a smooth surface finish and medium gloss. The overlay material may be any suitable color, with a durometer of 53±5 SHORE A, having a medium texture with a low to dull gloss. The dimension L in this case, measured with respect to the liner, is 2.33, or the thereabouts; W is 0.375; the thickness of the liner is on the order of 0.055, and the thickness of the overlay wall is preferably on the 0.100. Again, dimensions are metric, and variations to the preferred dimensions should be taken into account.

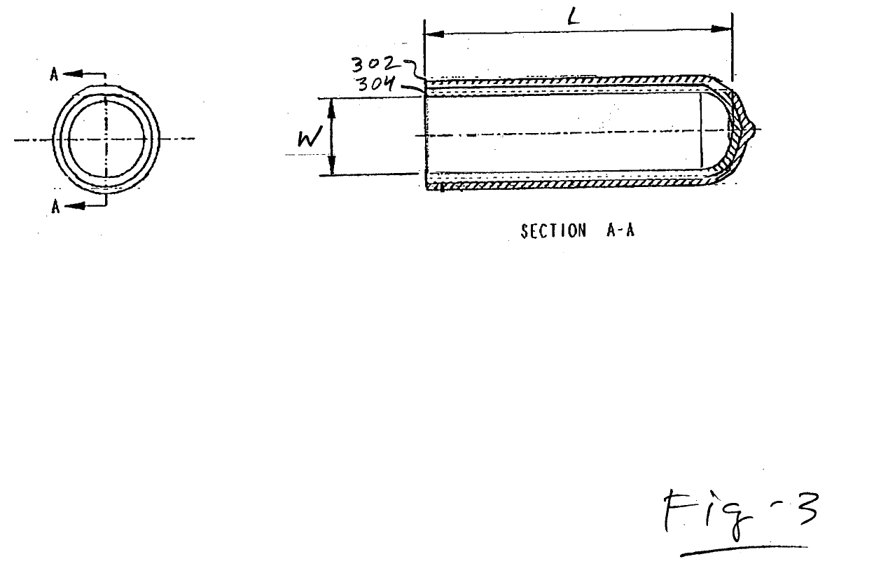

FIG. 3 is a drawing of a further alternative embodiment for a different spray bottle trigger, including a liner 302 and an overlay material 304. Both are preferably molded out of vinyl plastisol, with the liner preferably being natural in color and having a durometer of 75±5 SHORE A durometer, and an outside smooth surface finish with a medium gloss. The overlay material is preferably yellow, though certain other colors may be used, with a durometer of 30±5 SHORE A and a surface finish which is suede-like in texture. Other surface finishes may be used for any of the embodiments described herein, so long as they are appropriate to the application. The dimension L in FIG. 3 is on the order of 2.00; and W is on the order 0.500, or thereabouts. The thickness of the liner wall is on the order 0.055, and the thickness of the total, including the wall of the liner and overlay is on the order of 0.100, or thereabouts.

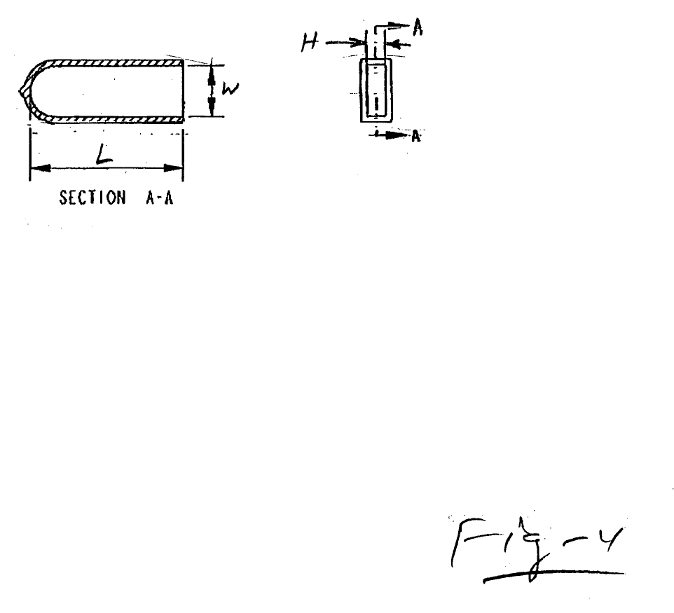

FIG. 4 illustrates yet a different alternative embodiment of the invention, intended for other types of trigger spray grips, having a generally rectangular cross-section with the dimension W on the order of 0.500, and H on the order of 0.1, or thereabouts. L is preferably on the order of 1.5, or thereabouts, and the wall thickness is on the order of 0.060. The material is again preferably vinyl plastisol, with a preferred color of red, though other colors may be used, a durometer of 53±5 SHORE A with a medium texture having a low to dull gloss.

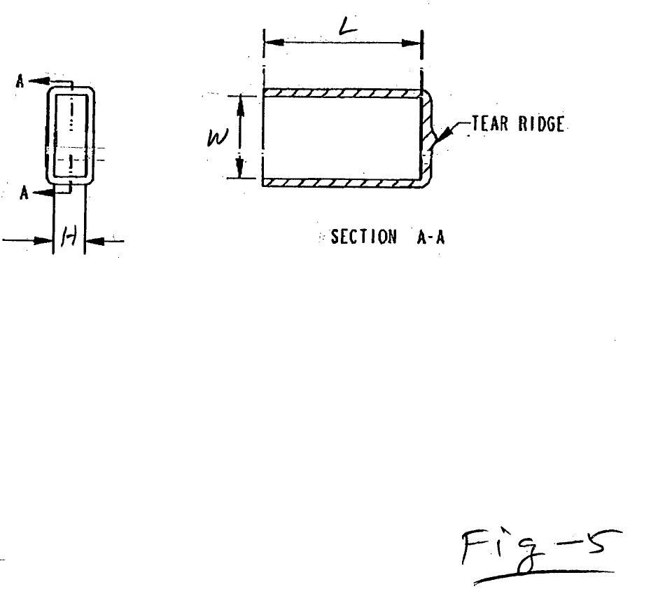

FIG. 5 illustrates a further, different alternative embodiment of the invention, for a different type of trigger handle. The generally rectangular cross-section is used, with a dimension H on the order 0.250; W on the order of 0.625; and L on the order of 1.250. The material is preferably vinyl plastisol, with a preferred color of yellow though others may be used. The durometer is preferably 53±5 SHORE A, with a surface finish of medium texture having a low to dull gloss.

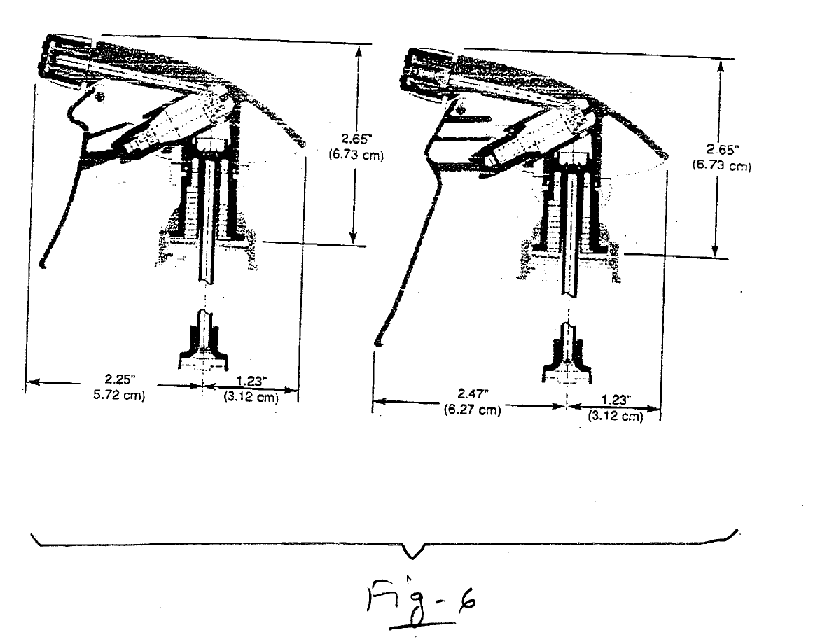

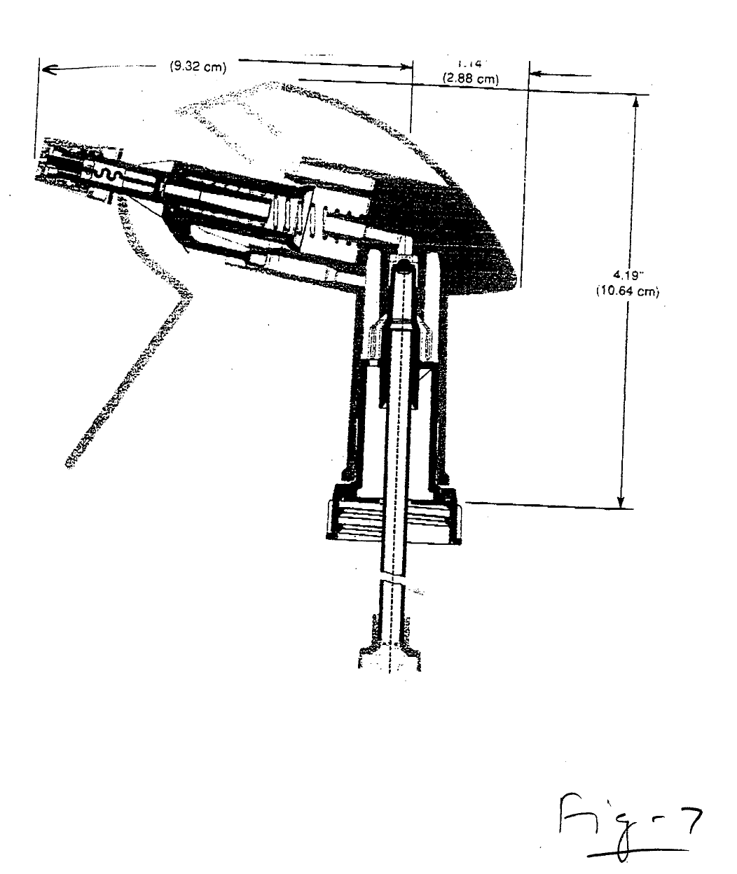

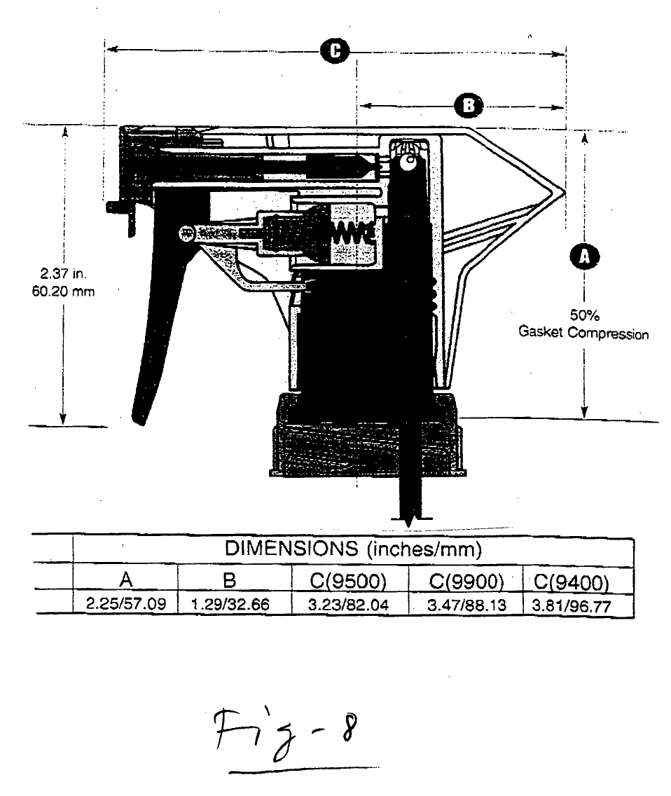

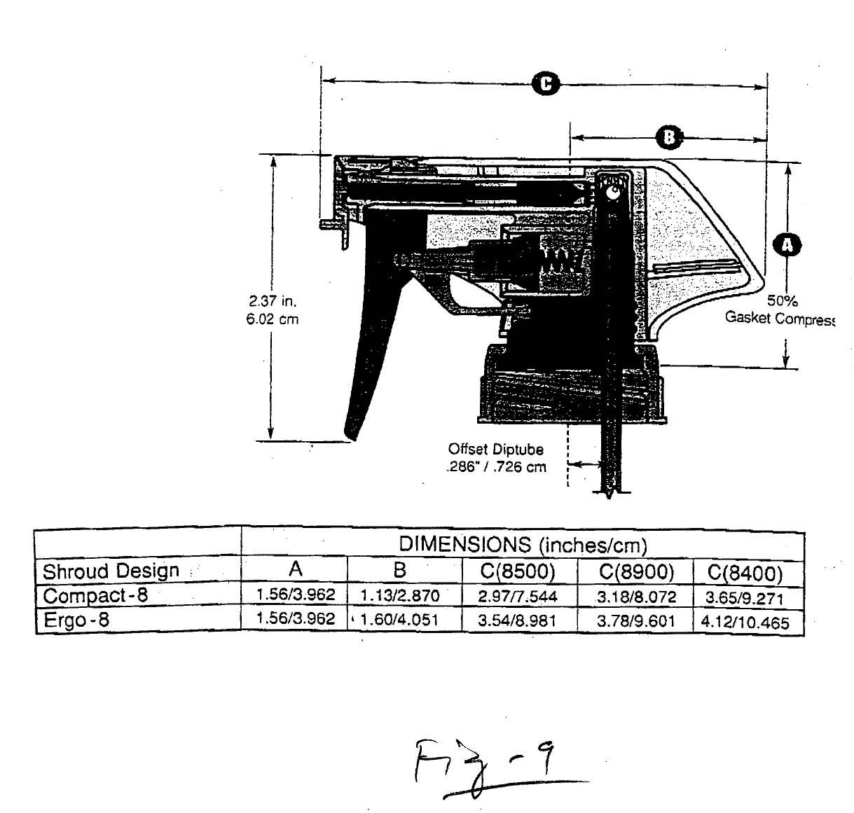

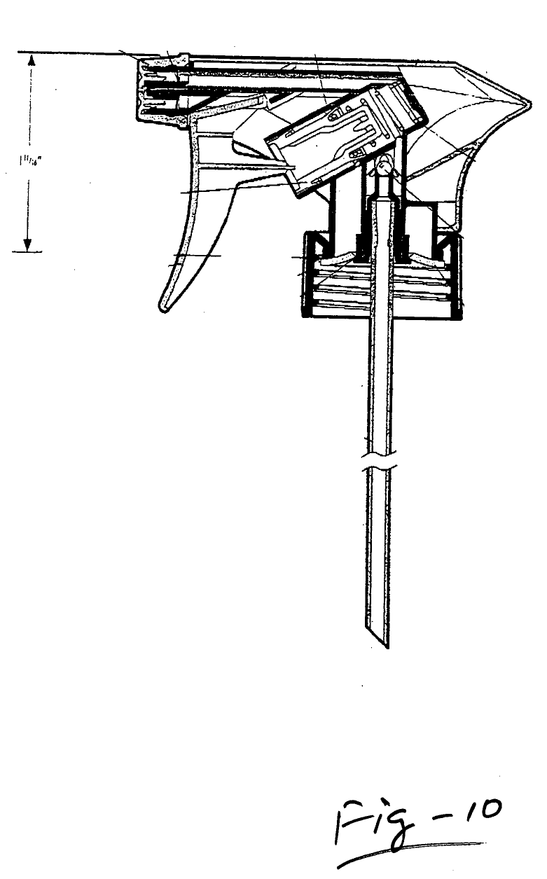

In terms of existing products, FIG. 6 is a specification for a spray head applicable to the cushion grips of FIGS. 1 and 2; FIG. 7 is a specification for a spray head applicable to the cushion grip of FIG. 3; FIGS. 8 and 9 are specifications for spray heads applicable to the cushion grip of FIG. 4; and FIG. 10 is a specification for a spray head applicable to the cushion grip of FIG. 5.

One of skill in the art will appreciate that these specifications are representative only, and that the cushion grips of FIGS. 1-5 may be applicable to appropriately dimensioned existing and yet-to-be-developed consumer, commercial and professional spray heads.

1. For use with a spray bottle having a manually operated, elongated trigger-type grip, a cover for the grip, comprising:
a sleeve of pliable material having an open end, a closed end, an internal length and an internal cross-sectional dimension; and wherein
the length is on the order 2.5 cm or less; and
internal cross-sectional dimension is on the order of 1 cm or less.

2. The cover of claim 1, wherein the internal cross section is circular.

3. The cover of claim 1, wherein the internal cross section is rectangular.

4. The cover of claim 1, wherein the sleeve of pliable material is composed of a coextensive liner and overlay.

5. The cover of claim 1, wherein the sleeve of pliable material has a durometer on the order of 25-100 SHORE A.

6. The cover of claim 1, wherein the sleeve of pliable material has a durometer on the order of 50 SHORE A.

7. The cover of claim 1, wherein:
the length measures from 1.35 to 1.4 cm; and
the internal cross section is circular with a diameter measuring 0.4 to 0.5 cm.

8. The cover of claim 1, wherein:
the length measures from 2.0 to 2.5 cm; and
the internal cross section is circular with a diameter measuring 0.35 to 0.4 cm.

9. The cover of claim 8, wherein the sleeve of pliable material is composed of a coextensive liner and overlay.

10. The cover of claim 9, wherein the sleeve has a combined wall thickness of 0.1 cm, or thereabouts.

11. The cover of claim 1, wherein:
the length measures approximately 2.0 cm; and
the internal cross section is circular with a diameter measures approximately 0.5 cm.

12. The cover of claim 11, wherein the sleeve of pliable material is composed of a coextensive liner and overlay.

13. The cover of claim 12, wherein the sleeve has a combined wall thickness of 0.1 cm, or thereabouts.

14. The cover of claim 1, wherein:
the length measures approximately 1.5 cm; and
the internal cross section is rectangular having internal cross-sectional dimensions of 0.1 by 0.5 cm, more or less.

15. The cover of claim 1, wherein:
the length measures approximately 1.25 cm; and
the internal cross section is rectangular having internal cross-sectional dimensions of 0.25 by 0.625 cm, more or less.
